(19) United States
(12) Patent Application Publication
(10) Pub. No.: US 2007/0031318 A1
(43) Pub. Date: Feb. 8, 2007

(54) Methods of chemically treating an electrically conductive layer having nanotubes therein with diazonium reagent

(76) Inventors: Jie Liu, Chapel Hill, NC (US); Lei An, Durham, NC (US)

Correspondence Address: FOLEY AND LARDNER LLP;SUITE 500, 3000 K STREET NW, WASHINGTON, DC, 20007, US

(21) Appl. No.: 11/196,519

(22) Filed: Aug. 3, 2005

(51) Int. Cl. D01F 9/12; B05D 3/04

(52) U.S. Cl. 423/447.1; 427/337

(57) ABSTRACT

Methods of treating an electronic device including an electrically conductive layer having single-walled semiconducting carbon nanotubes and single-walled metallic carbon nanotubes therein include the following step performed in the absence of an applied potential to the single-walled metallic carbon monotubes: chemically treating the electrically conductive layer with an aqueous solution having a first concentration of a diazonium reagent therein that is sufficient to convert at least some of the single-walled metallic carbon nanotubes to electrically insulating carbon nanotubes, but insufficient to convert more than 25% of the single-walled semiconducting carbon nanotubes to electrically insulating carbon nanotubes in the absence of an applied potential.

### STATEMENT OF GOVERNMENT SUPPORT

This invention was made with Government support under grant number CCR-0326157 from the National Science Foundation. The Government has certain rights to this invention.

### FIELD OF THE INVENTION

The invention generally relates to methods of treating an electrically conductive layer having single walled carbon nanotubes (SWNTs) on a substrate, and more particularly to methods of fabricating SWNT field effect transistors (FET) and FET sensors.

### BACKGROUND OF THE INVENTION

It is known that single walled carbon nanotubes (SWNTs) can be either semiconducting or metallic depending on their helicities. See Saito, R.; Dresselhaus, G.; Dresselhaus, M. S. Physicial Properties of Carbon Nanotubes; Imperial College Press: London, 1998. Typical methods for synthesizing SWNTs generally yield a mixture of semiconducting and metallic carbon nanotubes. These mixtures of semiconducting and metallic carbon nanotubes may be of limited use in electronic devices because the semiconducting and metallic materials have very different functions in electronic devices.

Efforts have been made to separate metallic and semiconducting carbon nanotubes. See Krupke, H.; Hennrich, F.; Lohneysen, H.; Kappes, M. M. Science 2003, 301, 344; Collins, P. G.; Arnold, M. S.; Avouris, P. Science 2001, 292, 706; Chattopadlhyay, D.; Galeska, I.; Papadimitrakopoulos, F., J. Am. Chem. Soc. 2003, 125, 3370; Strano, M. S.; Dyke C. A.; Usrey, M. L.; Barone, P. W.; Allen, M. J. Shan, H.; Kittrel, C.; Hauge, R. H.; Tour, J. M.; Smalley, R. E. Science 2003, 301, 1519; Kamaras, K.; Itkis, M. E.; Hu, H.; Zhao, B.; Haddon, R. C. Science 2003, 301, 1501; Banerjee, S.; Wong, S. S. J. Am. Chem. Soc. 2004, 126, 2073; and Chen, Z.; Du, X.; Raneken, C. D.; Cheng, H.; Rinzler, A. G. Nano Letters 2003, 3, 1245. For example, one approach to provide semiconducting SWNTs in an electronic device involves the application of a gate voltage on an FET before passing a large current to selectively burn away the metallic nanotubes from the device. Collins, P. G.; Arnold, M. S.; Avouris, P. Science 2001, 292, 706. This approach may be time consuming and labor intensive, and may not be easily used in larger scale production, such as when multiple devices are deposited on a wafer.

Another approach is to use a reagent with nanotubes suspended in solvents. For example, a reagent is added to a nanotube solution, which reacts with the metallic nanotubes so that they become insulators. The solution is then purified, and the nanotubes are separated to reduce the formation of nanotube bundles. The nanotubes are then deposited on a substrate. Current methods for purifying and separating SWNT structures employ a variety of physical and chemical treatments. However, the techniques typically employed for the purification of nanotubes in solution and nanotube separation may introduce defects into the resulting nanotube layer. The performance of electronic devices may therefore be decreased.

Another approach involves preconditioning each device before electrochemically removing the metallic nanotubes. Balasubramanian, K.; Sordan, R.; Burghard, M.; Kern, K. Nano Letters 2004, 4, 827 (“Balasubramanian”), the disclosure of which is hereby incorporated by reference in its entirety. Specifically, Balasubramanian proposes performing an electrochemical modification to a nanotube bundle in an existing FET. Prior to the electrochemical modification, a gate voltage is applied to the FET. A potential is then applied to a sample in a 10 mM 4-nitrobenzene diazonium salt solution in N,N-dimethylformamide (DMF) with 0.1 M lithium perchlorate as a background electrolyte. According to Balasubramanian, this process was performed on a single contacted bundle containing a mixture of both metallic and semiconducting SWNTs. Balasubramanian reports that the modification of the semiconducting tubes can be enabled or blocked by varying the history of the gate potential scans before performing electrochemistry, and that the conduction through the metallic nanotubes in a SWNT ensemble can be selectively eliminated in the FETs. However, the preconditioning of the gate potential scans can be time consuming and/or labor intensive. As a result, this process may not be easily scaled for large scale applications, such as for a large number of devices on a wafer. Balasubramanian also reports that control experiments were performed without applying a potential, but that no changes in conductance were observed for either metallic or semiconducting nanotubes.

### SUMMARY

According to embodiments of the present invention, methods of treating an electronic device including an electrically conductive layer having single-walled semiconducting carbon nanotubes and single-walled metallic carbon nanotubes therein include the following step performed in the absence of an applied potential to the single-walled metallic carbon monotubes: chemically treating the electrically conductive layer with an aqueous solution having a first concentration of a diazonium reagent therein that is sufficient to convert at least some of the single-walled metallic carbon nanotubes to electrically insulating carbon nanotubes, but insufficient to convert more than 25% of the single-walled semiconducting carbon nanotubes to electrically insulating carbon nanotubes.

According to further embodiments of the present invention, methods of treating an electrically conductive layer having single-walled semiconducting carbon nanotubes and single-walled metallic carbon nanotubes therein include the following step performed in the absence of an applied potential to the single-walled metallic carbon monotubes: exposing the electrically conductive layer to an aqueous solution having a first concentration of a diazonium reagent therein that is sufficient to convert at least a majority of the single-walled metallic carbon nanotubes to electrically insulating carbon nanotubes, but insufficient to convert more than 25% of the single-walled semiconducting carbon nanotubes to electrically insulating carbon nanotubes.

According to embodiments of the present invention, methods of treating an electronic device including an electrically conductive layer having single-walled semiconducting carbon nanotubes and single-walled metallic carbon nanotubes therein include the following step performed in the absence of an applied potential to the single-walled metallic carbon monotubes: chemically treating the electrically conductive layer with an aqueous solution having a first concentration of a diazonium reagent therein that is sufficient to convert at least some of the single-walled metallic carbon nanotubes to electrically insulating carbon nanotubes.

### BRIEF DESCRIPTION OF THE DRAWINGS

FIGS. 1-3 are flowcharts illustrating processes for reducing metallic nanotubes in a nanotube layer on a substrate according to embodiments of the present invention.

FIG. 4 is a graph illustrating the gate dependence curves of the current (nA) and gate voltage (V) of a SWNT device according to embodiments of the present invention. Curve A is the dependence curve of a device before a diazonium reaction. Curve B is the dependence curve of the device alter a reaction with 5.3×¹⁰⁻7 μM of diaonium reagent. Curve C is a dependence curve after a further reaction with 5.3×¹⁰⁻7 μM of diazonium reaction. Curve D is a dependence curve after annealing.

FIG. 5 is a graph illustrating the gate dependence curves of a device according to embodiments of the present invention. Curve A is the dependence curve of a device before a diazonium reaction. Curve B is the dependence curve of the device after a reaction with 5.3×¹⁰⁻7 μM of diaonium reagent. Curve C is a dependence curve after a further reaction with 5.3×¹⁰⁻7 μM of diazonium reaction. Curve D is after a reaction with 3.7 mM diazonium salts. Curve E is after a second reaction with 3.7 mM diazonium salts. Curve F is after a third reaction with 3.7 mM diazonium salts.

### DETAILED DESCRIPTION OF EMBODIMENTS OF THE INVENTION

Embodiments according to the present invention now will be described more fully hereinafter with reference to the accompanying drawings and examples. Embodiments according to the present invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the thickness of layers and regions may be exaggerated for clarity. Like numbers refer to like elements throughout. As used herein the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The structure of nanotube-based FETs and the use of layers of SWNTs in the channel region of FETs are known. See Zheng, B.; Lu, C.; Gu, G.; Makarovski, A.; Finkelstein, G.; Liu, J. Nano Letters 2002, 2, 895; An, L.; Owens, J. M.; McNeil, L. E.; Liu, J. J. Am. Chem. Soc. 2002, 124, 13688; and U.S. Pat. No. 6,891,227 to Appenzeller et al., the disclosures of which are hereby incorporated by reference in their entireties. FET based sensors are also known. See U.S. Patent Application No. 2004/013070 to Star et al., the disclosure of which is hereby incorporated by reference in its entirety.

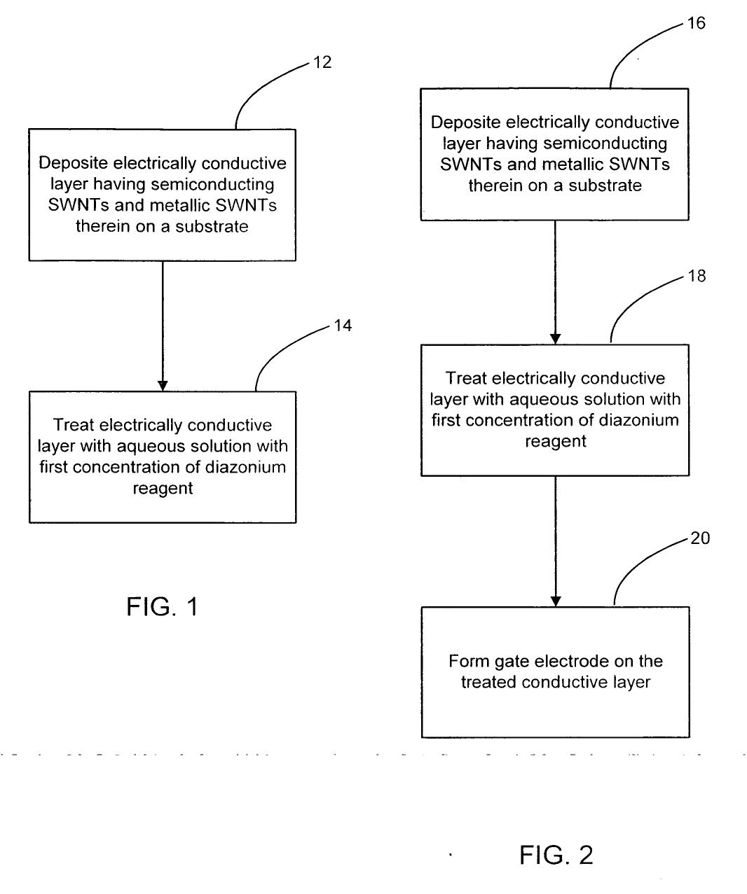

According to embodiments of the present invention and as illustrated in FIG. 1, an electrically conductive layer is deposited on a substrate at Block 12. The electrically conductive layer has semiconducting SWNTs and metallic SWNTs therein. At Block 14, the electrically conductive layer is chemically treated with an aqueous solution having a first concentration of a diazonium reagent therein. In some embodiments, the first concentration is sufficient to convert at least some of the metallic SWNTs to insulating SWNTs, but insufficient to convert more than about 25% of the semiconducting SWNTs to electrically insulating SWNTs. See An, L.; Liu, J., “A simple chemical route to selectively eliminate metallic carbon nanotubes in nanotube network devices,” Journal of the American Chemical Society, 126, 10520-10521 (Sep. 1, 2004; web release date: Aug. 4, 2004), the disclosure of which is hereby incorporated by reference in its entirety.

The chemical treatment may be performed in the absence of an applied potential, and the electrically conductive layer may be chemically treated without requiring all electrochemical process. Moreover, preconditioning of the electrically conductive layer, for example, by applying a gate voltage to a gate on the electrically conductive layer, such as is reported in Balasubramanian, may be omitted. Accordingly, the chemical treatment may be performed prior to the fabrication of a gate on the electrode. The chemical treatment may also be performed on a monolayer of SWNTs, i.e., a layer of SWNTs that is one nanotube thick.

In some embodiments, the concentration of diazonium reagent is sufficient to convert at least a majority of the metallic SWNTs to electrically insulating SWNTs. In particular embodiments, the concentration of diazonium reagent is sufficient to convert at least 80% or at least 90% of the metallic SWNTs to electrically insulating SWNTs. More specifically, the concentration of diazonium reagent may be between about 1 mM and 1×10⁻¹⁰ mM. The chemical treatment may be performed for a duration of between about 10 seconds and 30 minutes and/or at a temperature of between about 10° C. and 75° C.

In particular embodiments, the concentration of diazonium reagent may be estimated by estimating a number of SWNTs in the electrically conductive layer and estimating the concentration based on the estimated number of SWNTs. For example, a scanning electron microscope (SEM) picture of the electrically conductive layer may be used to estimate the number of SWNTs in the electrically conductive layer. The SEM picture may be used to select a concentration so that only a relatively small portion of carbon atoms would be reacted, for example, 10-20 carbons out of 1000 carbons.

In some embodiments, the electrically conductive layer after chemical treatment has more than about 99% semiconducting SWNTs or insulating SWNTs

With reference to FIG. 2, Blocks 16 and 18 correspond generally to Blocks 12 and 14 of FIG. 1, respectively. After chemically treating the electrically conductive layer at Block 18, a gate electrode may be formed on the treated conductive layer. Subsequent processing steps may be performed, for example, to provide an FET or FET-based sensor. The electrically conductive layer may become semiconducting as a result of the chemical treatment, and may provide a channel region for an FET.

With reference to FIG. 3, Blocks 22 and 24 correspond generally to Blocks 12 and 14 of FIG. 1, respectively. At Block 26, thermal processing of any subsequent fabrication steps are limited to reduce or prevent annealing. Without wishing to be bound by theory, annealing may cause the insulating SWNTs to become metallic once again. Accordingly, if the SWNTs are used as channel region of an FET, the subsequent fabrication steps may include steps to fabricate source/drain regions, a gate insulating layer, and/or a gate electrode. It should be understood, however, that the chemical treatment of the electrically conductive layer and the SWNTs therein may be performed either before or after the fabrication of various FET components.

Further embodiments according to the present invention will be described with respect to the following non-limiting example.

### EXAMPLE

Single walled carbon nanotube (SWNT) devices were prepared using a chemical vapor deposition (CVD) system having a heated one inch quartz tube and a gas handling system, and a two-step photolithography process. First, catalyst islands were lithographically patterned on silicon substrates with 1 μm thick thermally grown oxide using Poly Methyl Methacrylate (PMMA) or Photoresist 1813 from Shipley. An aqueous suspension of 0.05 mmol Co(NO₃)₂.6H₂O, 0.15 mmol MoO₂(acac)₂ and 15 mg alumina powder per 15 mL water was used to deposit the catalyst islands. The catalysts were annealed at 500° C. in air for five minutes and reduced at 800° C. in H₂ (200 sccm) for five minutes before being exposed to ethanol carried by Ar (1000 sccm) for ten minutes to grow SWNTs. Then the electrodes were patterned on the top of the catalyst islands, followed by a metal evaporation (5 nm Cr and 30 nm Au) and liftoff. The gap between the electrodes was about 5 μm. The devices were then annealed at 300° C. in Ar atmosphere for thirty minutes before the electrical measurements and chemical modification.

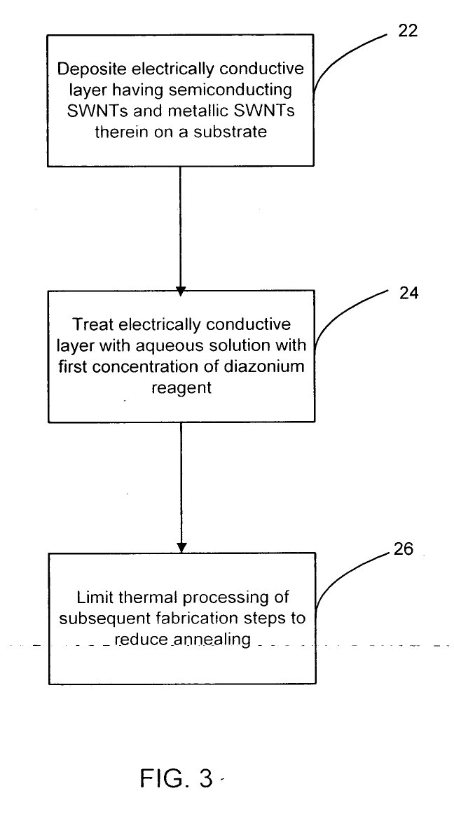

The concentration of the diazonium reagent was selected so the concentration was sufficient to convert at least some of the metallic SWNTs to electrically insulating SWNTs and insufficient to convert more than 25% of the semiconducting SWNTs to insulting SWNTs. For example, a rough estimation of the total number of nanotubes in the device was made from a scanning electron microscope (SEM) picture. The reaction was conducted with a concentration of diazonium reagent estmated to be sufficient so that only a relatively small portion of carbon atoms would be reacted, for example, 10-20 carbons out of 1000 carbons. The concentrations of the diazonium reagent varied with different samples. For example, a drop of 5.3×10⁻⁷ μM aqueous solution of the diazoniuim reagent was placed on the top of the device and the reaction time was about ten minutes. As shown in FIG. 4 after the first reaction, the off-state current decreased about 74% while the on-state current decreased only about 15%. This may indicate that most of the metallic nanotubes were eliminated (i.e., became insulating) and the semiconducting nanotubes were substantially intact. A second reaction was carried out on the same sample. Subsequently, the device was turned off at a positive gate voltage while the on-state current was left almost unaffected. The selectivity of the diazonium reaction appeared successful. Finally, the sample was annealed at 300° C. in Ar for thirty minutes and the aryl functional groups on the nanotubes underwent cleavage in the inert gas atmosphere. The device recovered back to a level close to that before the reactions. Accordingly, the annealing process may cause the insulating tubes to become metallic once again. Therefore, it may be desirable to limit thermal processing of the electronic device after the chemical treatment.

In this example, the chemical treatment is conducted in the absence of an applied potential and no gate voltage is applied prior to the chemical reaction with the diazonium reagent.

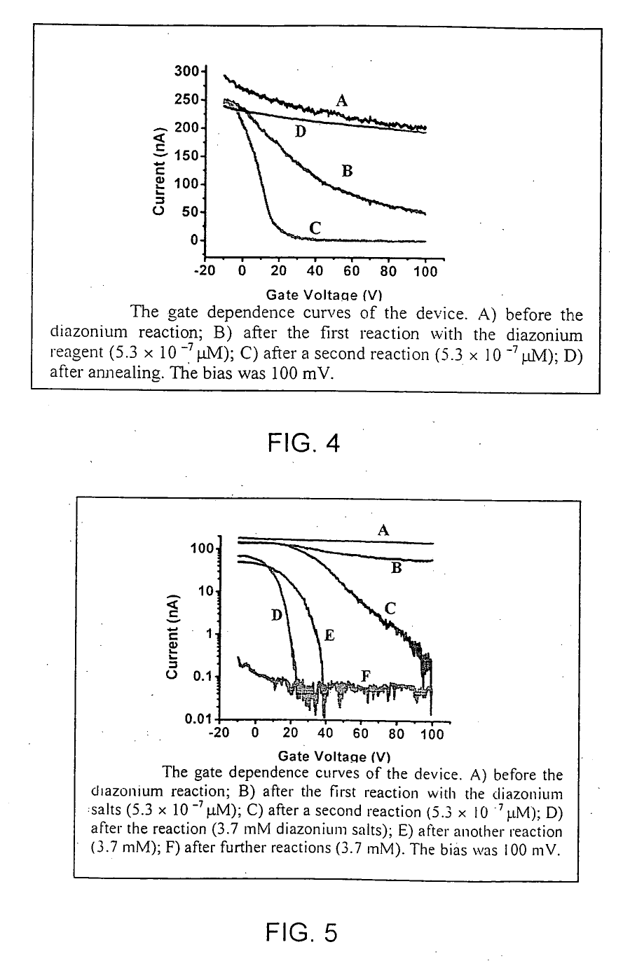

A different set of measurements are illustrated in FIG. 5, which shows the current plotted in a logarithmic scale to illustrate variations due to diazonium reagent concentration levels. The off-state conductance dropped about 59% while the on-state current only decreased about 18% after the first reaction. A second reaction kept the on-state current the same and resulted in the substantial elimination of metallic nanotubes as indicated by the infinitesimal current at the turn-off state. The ON and OFF current ration is approaching 10⁵ and it is limited by the instrumentation used, which have a resolution to more than 10 pA.

The concentration of diazonium reagent was increased to 3.7 mM and the reaction time was kept at about 10 minutes. As a result the on-state conductance was reduced to about 50%, indicating that some of the semiconducting nanotubes may have reacted with the diazonium reagent. Further reaction with an excessive amount of diazonium reagent reduced the on-state current about another 30%. Finally, the device became insulating after successive reactions, possibly because all of the semiconducting nanotubes had been reacted. Without wishing to be bound by theory, this data may demonstrate that the selectivity of the reaction between the diazonium reagent and carbon nanotubes may be obtained by controlling the concentration of diazonium reagent used. Another possibility is that the observed selectivity might relate to metallic nanotubes being more sensitive to a small number of defects introduced by the reaction than semiconducting nanotubes.

In the drawings and specification, there have been disclosed embodiments of the invention and, although specific teens are employed, they are used in a generic and descriptive sense only and not for purposes of limitation, the scope of the invention being set forth in the following claims.

That which is claimed:

1. A method of treating an electrically conductive layer having single-walled semiconducting carbon nanotubes and single-walled metallic carbon nanotubes therein, the method comprising the following step performed in the absence of an applied potential to the single-walled metallic carbon nanotubes:
chemically treating the electrically conductive layer with an aqueous solution having a first concentration of a diazonium reagent therein that is sufficient to convert at least some of the single-walled metallic carbon nanotubes to electrically insulating carbon nanotubes, but insufficient to convert more than 25% of the single-walled semiconducting carbon nanotubes to electrically insulating carbon nanotubes.

2. The method of claim 1, wherein the first concentration of diazonium reagent is sufficient to convert at least a majority of the single-walled metallic carbon nanotubes to electrically insulating carbon nanotubes.

3. The method of claim 1, wherein the first concentration of diazonium reagent is sufficient to convert at least 80% of the single-walled metallic carbon nanotubes to electrically insulating carbon nanotubes.

4. The method of claim 1, wherein the first concentration of diazonium reagent is sufficient to convert at least 90% of the single-walled metallic carbon nanotubes to electrically insulating carbon nanotubes.

5. The method of claim 1, further comprising forming a gate electrode on the electrically conductive layer after the chemically treating step.

6. The method of claim 1, further comprising limiting thermal processing of the electrically conductive layer to reduce annealing after the chemically treating step.

7. The method of claim 1, further comprising depositing the electrically conductive layer on a substrate prior to the chemically treating step.

8. The method of claim 1, wherein the first concentration of diazonium reagent is between about 1 mM and 1×¹⁰⁻10 mM.

9. The method of claim 8, wherein the chemically treating step is performed for a duration of between about 10 seconds and 30 minutes.

10. The method of claim 8, wherein the chemically treating step is performed at a temperature of between about 10° C. and 75° C.

11. The method of claim 1, further comprising:
estimating a number of carbon nanotubes in the electrically conductive layer; and
estimating the first concentration of diazonium reagent based on the estimated number of carbon nanotubes in the electrically conductive layer.

12. The method of claim 11, wherein estimating a number of carbon nanotubes in the electrically conductive layer comprises estimating a number of carbon nanotubes based on a scanning electron microscope (SEM) picture of the electrically conductive layer.

13. The method of claim 1, wherein the electrically conductive layer comprises more than about 99 percent semiconducting carbon nanotubes or insulating carbon nanotubes after the chemically treating step.

14. The method of claim 1, wherein the electrically conductive layer comprises a monolayer of carbon nanotubes.

15. A method of treating an electrically conductive layer having single-walled semiconducting carbon nanotubes and single-walled metallic carbon nanotubes therein, the method comprising the following step performed in the absence of an applied potential to the single-walled metallic carbon nanotubes:
exposing the electrically conductive layer to an aqueous solution having a first concentration of a diazonium reagent therein that is sufficient to convert at least a majority of the single-walled metallic carbon nanotubes to electrically insulating carbon nanotubes, but insufficient to convert more than 25% of the single-walled semiconducting carbon nanotubes to electrically insulating carbon nanotubes in the absence of an applied potential.

16. A method of treating an electronic device comprising an electrically conductive layer having single-walled semiconducting carbon nanotubes and single-walled metallic carbon nanotubes therein, the method comprising the following step performed in the absence of an applied potential to the single-walled metallic carbon nanotubes:
chemically treating the electrically conductive layer with an aqueous solution having a first concentration of a diazonium reagent therein that is sufficient to convert at least some of the single-walled metallic carbon nanotubes to electrically insulating carbon nanotubes.

17. A method of treating an electrical device comprising an electrically conductive layer having single-walled semiconducting carbon nanotubes and single-walled metallic carbon nanotubes therein, the method comprising the following step performed in the absence of an applied potential to the single-walled metallic carbon nanotubes:
chemically treating the electrically conductive layer with an aqueous solution having a first concentration of a diazonium reagent therein that is sufficient to convert at least some of the single-walled metallic carbon nanotubes to electrically insulating carbon nanotubes, but insufficient to convert more than 25% of the single-walled semiconducting carbon nanotubes to electrically insulating carbon nanotubes.
